(19) United States
(12) Patent Application Publication
(10) Pub. No.: US 2004/0204954 A1
(43) Pub. Date: Oct. 14, 2004

(54) Virtual pharmacy kiosk system

(76) Inventor: Joe Lacko, Edison, NJ (US)

Correspondence Address: NIXON & VANDERHYE, PC, 1100 N GLEBE ROAD, 8TH FLOOR, ARLINGTON, VA, 22201-4714, US

(21) Appl. No.: 10/623,797

(22) Filed: Jul. 22, 2003

Related U.S. Application Data
(60) Provisional application No. 60/397,604, filed on Jul. 23, 2002.

(51) Int. Cl. G06F 17/60

(52) U.S. Cl. 705/1; 709/204

(57) ABSTRACT

A system and method for providing pharmacy services to a customer at a location where a live pharmacist is not available. The system includes a pharmacy kiosk computer system including a videoconference arrangement, a document scanner and a communication system, and a servicing pharmacy computer system remotely located from the pharmacy kiosk computer system and including a videoconference arrangement and a communication system. The pharmacy kiosk and the servicing computer are interconnected via their respective wired or wireless communication systems in a manner that enables a pharmacy service videoconference to be established between a customer located at the pharmacy kiosk and a live pharmacist at the servicing computer. Prescription, identification, insurance and/or payment information can be transmitted from the kiosk to the servicing computer in order to obtain pharmacy services.

### RELATED APPLICATION

This application claims domestic priority on U.S. provisional application serial No. 60/397,604, filed Jul. 23, 2002 and entitled “Virtual Pharmacy Kiosk System,” the entire content of which is incorporated by reference herein.

### FIELD OF THE INVENTION

The instant invention relates to pharmacy services and, more particularly, to a system and method for enabling a live pharmacist to provide pharmacy services to customers at remote locations where a live pharmacist is not available or remote areas of a store or health facility. The system and method of the instant invention enable customers at a remote location, such as a store in which the pharmacy is currently closed, to communicate with a live pharmacist at another location, such as a store in which the pharmacy is open, in order to obtain pharmacy services, such as advice or filling or refilling of prescriptions. The instant invention enables a video conference to be established between the customer and the live pharmacist, as well as enables the customer to scan and transmit information, such as prescriptions, identification, insurance information and/or payment information, to the live pharmacist for viewing, printing and/or processing.

### BACKGROUND AND SUMMARY OF THE INVENTION

It is important for many people that a pharmacist be available in order to have prescriptions filled and/or to have access to other types of pharmacy services. It is also important for many people that pharmacy services can be obtained in a timely and convenient manner. Many stores, such as drugstores, include pharmacies. However, not all pharmacies have a pharmacist on duty at all times. Thus, customers desiring pharmacy services may either have to wait until the pharmacy is open or travel to another location having a pharmacy that is open. Finding an open pharmacy can sometimes be time-consuming and inconvenient. Thus, a need exists for a system and method for improving the accessibility of pharmacy services in a convenient and advantageous manner. The present invention was developed to address this and other related needs.

In accordance with a primary aspect of the instant invention, a system is provided for providing pharmacy services to customers at a location where a live pharmacist is not available. The system includes a pharmacy kiosk computer system including a videoconference arrangement (e.g., camera, speaker and microphone), a document scanner and a communication system, and a servicing pharmacy computer system remotely located from the pharmacy kiosk computer system and including a videoconference arrangement (e.g., camera, speaker and microphone) and a communication system. The pharmacy kiosk computer system and the servicing pharmacy computer system are interconnected via their respective communication systems in a manner that enables a pharmacy service videoconference to be established between a customer located at the pharmacy kiosk computer system and a live pharmacist at the servicing pharmacy computer system. The system also enables information scanned on the document scanner of the pharmacy kiosk computer system to be transmitted to the servicing pharmacy computer system for review by the live pharmacist. The document scanner enables prescriptions, as well as insurance and identification information, to be scanned and transmitted to the servicing pharmacy computer system for review by the pharmacist. The pharmacist can then display or print the transmitted information. The pharmacy kiosk computer system may also include a payment scanner which enables payment (e.g., credit/debit card) information for the pharmacy service to be transmitted from the pharmacy kiosk computer system to the servicing pharmacy computer system.

In accordance with another aspect of the invention, the pharmacy kiosk computer system is preferably located in a store having a pharmacy, and the pharmacy kiosk computer system is designed for use when the store is open but the pharmacy is closed. The servicing pharmacy computer system is preferably located at a pharmacy and is designed for use by a pharmacist working at the pharmacy. In this way, the pharmacist can, for example, service customers at stores (e.g., drugstores) that are open but do not currently have a pharmacist on duty.

In accordance with another aspect of the invention, the pharmacy kiosk computer system includes a handset that includes a speaker in an ear piece and a microphone in a mouth piece for enabling private communications with the live pharmacist during the pharmacy service videoconference. A speaker on the kiosk is disabled when the handset is picked up, thereby improving the privacy of the videoconference for the customer.

A further aspect of the invention is for the pharmacy kiosk computer system to include a touchscreen that can be used by the customer to activate and to interact with the pharmacy kiosk computer system. Upon activation of the pharmacy kiosk computer system by a customer, an indication (e.g., ringing tone) is provided by the servicing pharmacy computer system to the live pharmacist in order to notify the pharmacist that a customer at the pharmacy kiosk computer system is requesting pharmacy services. The pharmacist can then accept the incoming conference request in order to begin a pharmacy service conference. The pharmacy kiosk computer system may also include a motion sensor that activates an attract mode on the pharmacy kiosk computer system when a potential customer is within a predetermined distance from the pharmacy kiosk computer system.

In accordance with a further aspect of the invention, the pharmacy kiosk computer system and the servicing pharmacy computer system are interconnected via their respective communication systems using any suitable communications medium, including, but not limited to, high-speed telephone connections, the Internet, satellite, cable, or other wired or wireless technology. The system may also include a plurality of the pharmacy kiosk computer systems at different locations, wherein each of the plurality of pharmacy kiosk computer systems are interconnected with a centralized servicing pharmacy computer system, thereby enabling the live pharmacist at the centralized facility to service various customers at the different locations.

In accordance with yet another aspect of the invention, a method is provided for providing pharmacy services to a customer at a location where a live pharmacist is not available. The method includes: providing a pharmacy kiosk computer system at a first location for use by the customer needing pharmacy services; providing a servicing pharmacy computer system for use by a pharmacist at a second location remote from the first location; establishing a pharmacy services videoconference between the customer at the pharmacy kiosk computer system and the pharmacist at the servicing pharmacy computer system; conducting a videoconference between the customer and the pharmacist; providing information from the customer to the pharmacist in order to enable the pharmacist to service the customer; and ending the pharmacy services videoconference.

The information provided from the customer to the pharmacist includes prescription information, identification information, insurance information and/or payment information. The information is preferably scanned using a document scanner on the pharmacy kiosk computer system and then transmitted to the servicing pharmacy computer system. Delivery or pick-up instructions may also be obtained from the customer during the pharmacy services videoconference. After the information has been collected from the customer and the videoconference has been terminated, the pharmacist fills or refills a prescription for the customer in the conventional manner based on the information received. The filled or refilled prescription is then delivered for the customer in accordance with the delivery instructions received from the customer during the pharmacy services videoconference. The original prescription can be collected from the customer, as needed, when the prescription is delivered or picked up.

### BRIEF DESCRIPTION OF THE DRAWINGS

These and other features, objects and advantages of the instant invention will be better understood by review of the following detailed description of the preferred embodiments of the invention when read in conjunction with the appended drawings, in which:

FIG. 1 shows a front elevational view of an exemplary remote pharmacy kiosk system used to establish a video conference with a live pharmacist, in accordance with a preferred embodiment of the instant invention;

FIG. 2 shows a live pharmacist being displayed on the screen of the remote pharmacy kiosk system of FIG. 1, thereby enabling a customer at the pharmacy kiosk system to communicate with and obtain services from the displayed live pharmacist;

FIG. 3 shows a computer system adapted as a servicing pharmacy computer system for use by the live pharmacist when servicing a customer at the remote pharmacy kiosk system of FIG. 1, in accordance with a preferred embodiment of the instant invention;

FIG. 4 shows a high-level flow chart of the main steps performed in accordance the preferred embodiment of the instant invention in order to provide remote pharmacy services using the pharmacy kiosk system of FIG. 1 and the servicing pharmacy computer of FIG. 3;

FIG. 5 is a schematic diagram of the overall virtual pharmacy system in accordance with a first embodiment of the instant invention, wherein the virtual pharmacy kiosk is directly connected to the servicing pharmacy computer system;

FIG. 6 is a schematic diagram of the overall virtual pharmacy system in accordance with a second embodiment of the instant invention, wherein the virtual pharmacy kiosk is connected to the servicing pharmacy computer system through a communications network, such as the Internet; and

FIG. 7 is a schematic diagram of the overall virtual pharmacy system in accordance with a third embodiment of the instant invention, wherein a plurality of virtual pharmacy kiosks are connected to the servicing pharmacy computer system using a plurality of different connection types.

### DETAILED DESCRIPTION OF THE PREFERRED EMBODIMENTS

The following description of the preferred embodiment of the invention is meant to be exemplary only and is not intended to limit the invention to the specific details described. As one skilled in the art will readily understand from review of the description of the invention herein, various changes in detail and construction of the invention can be made without departing from the true scope and spirit of the invention as defined by the appended claims.

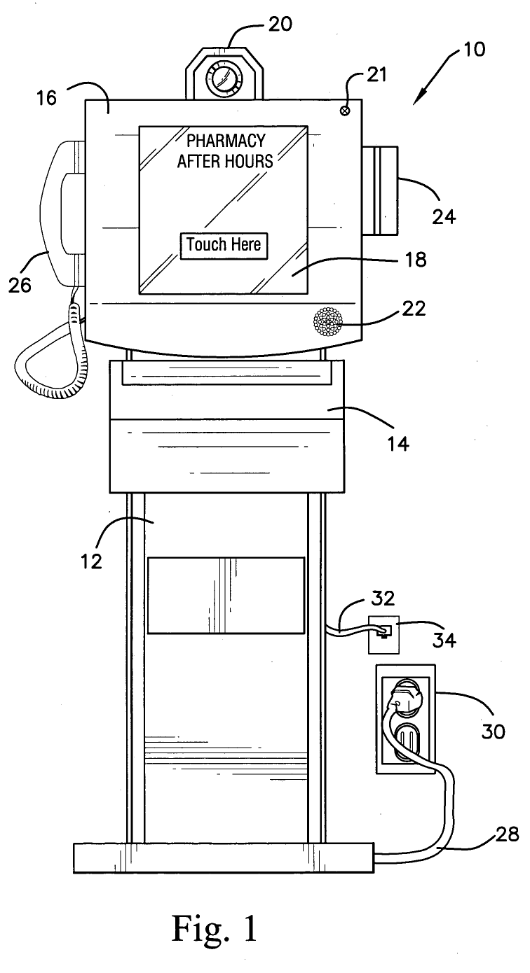

Referring now to the drawings, wherein like reference numerals designate similar parts throughout the various views, FIG. 1 shows an exemplary embodiment of the pharmacy kiosk computer system 10 in accordance with the instant invention. As shown in FIG. 1, the pharmacy kiosk computer system 10 includes a housing and base portion 12 which houses a computer system having software thereon that controls the operation of the kiosk system 10 in the manner described herein. The computer system can be any suitable type of computer system. Mounted on the housing portion 12 is a computer monitor 16 having a display with a touchscreen 18. One or more speakers and microphones 22 are also provided on the kiosk 10 at any suitable location. A camera 20 is mounted on the top of the computer monitor 20 and is oriented to video a customer standing at the kiosk 10. The speaker, microphone and camera comprise a videoconference system for the kiosk 10. A card reader, such as a credit card reader 24, is also operatively mounted on the side of the computer monitor 16. A handset 26, preferably in the form of a telephone handset, is also mounted on the kiosk 10 for use by the customer when additional privacy is needed. In other words, the handset can be used instead of the speaker and microphone 22 when using the kiosk 10. The kiosk 10 is preferably operable to mute the speaker and microphone 22 when the handset 26 is picked up. The kiosk 10 further includes a scanner 14 operable to scan documents and the like. The computer system, monitor, videoconference system, card reader, handset and document scanner are all functionally interconnected to perform the functions described herein. The kiosk 10 is powered by a conventional power outlet 30 using a power cord 28. The computer system also includes a communication system that is operable to communicate over any desired communications medium using communication line 32. For example, the communication line 32 may be connected, via outlet 34, to a T1 telecommunications line for high-speed communications. A motion sensor 21 may also be provided on the kiosk 10 in order to initiate an attract mode when a potential customer comes near the kiosk.

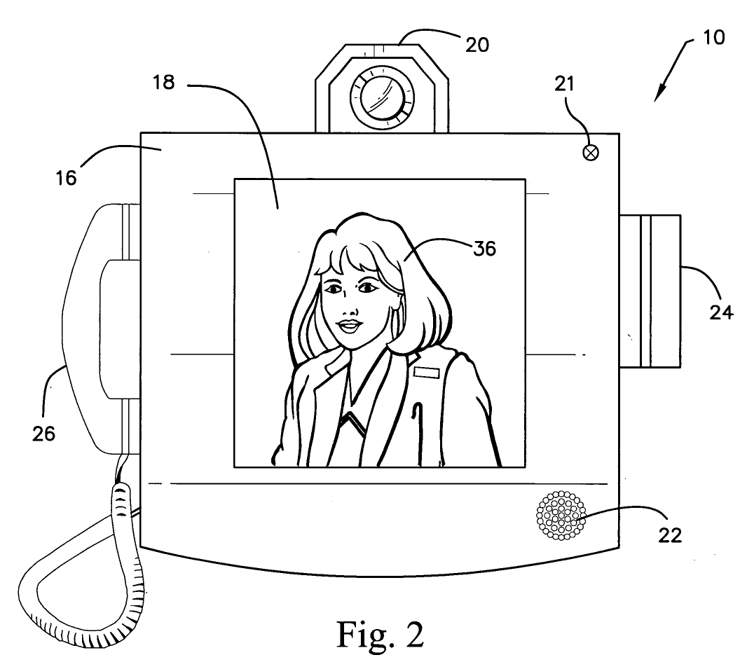

In the preferred embodiment, the pharmacy kiosk computer system 10 waits for a customer to touch the touchscreen 18 in order to activate the kiosk and enable pharmacy services to be obtained. FIG. 2 shows the monitor 16 of the kiosk after being activated and having a videoconference established between the customer at the kiosk 10 and a live pharmacist 36 at another location. The live pharmacist may be located at any remote location that is not readily accessible to the customer. During the videoconference, the customer and the pharmacist 36 can discuss any desired matters as if the customer was actually at a real pharmacy talking directly with the pharmacist. During the pharmacy services videoconference, the customer can scan a prescription using the scanner 14 and transmit the scanned image to the pharmacist 36. Any other necessary or desired documents or information can also be scanned, as desired, in order to obtain the desired pharmacy services. For example, the customer can scan identification and insurance information for transmission to the pharmacist 36. In addition, the customer can scan payment information, if desired, using the card reader 24, in order to transmit payment information the pharmacist 36. In this way, the pharmacist can obtain all of the necessary information in order to provide the requested pharmacy services to the customer.

As will be appreciated by those skilled in the art, other than the manner in which the communication is performed between the pharmacist and the customer and how the information is provided to the pharmacist for processing, the remaining steps performed by the pharmacist can be done in a conventional manner. For example, the pharmacist checks the prescription using the pharmacy database, adjudicates the insurance claim, and/or verifies payment using conventional techniques and processes. If requested by the customer, the pharmacist can then fill or refill the prescription based on the information transmitted from the kiosk 10. Then, of course, the filled prescription needs to be given to the customer. In accordance with the preferred embodiment of the invention, the customer provides delivery or pick up instructions to the pharmacist 36 during the pharmacy services videoconference. After the videoconference has ended, the pharmacist provides the product to the customer in the manner indicated during the videoconference. For example, the customer may desire to have the product delivered directly to the customer at home, work or any other designated location. The product may also be mailed to the customer, if desired. Alternatively, the customer could specify a pharmacy or store where the customer desires to pick up the product. It is also possible that the customer may want to pick up the product at the pharmacy where the live pharmacist 36 is located or another pharmacy outlet. If so, the pharmacist simply makes the product available for pickup by the customer at the designated location.

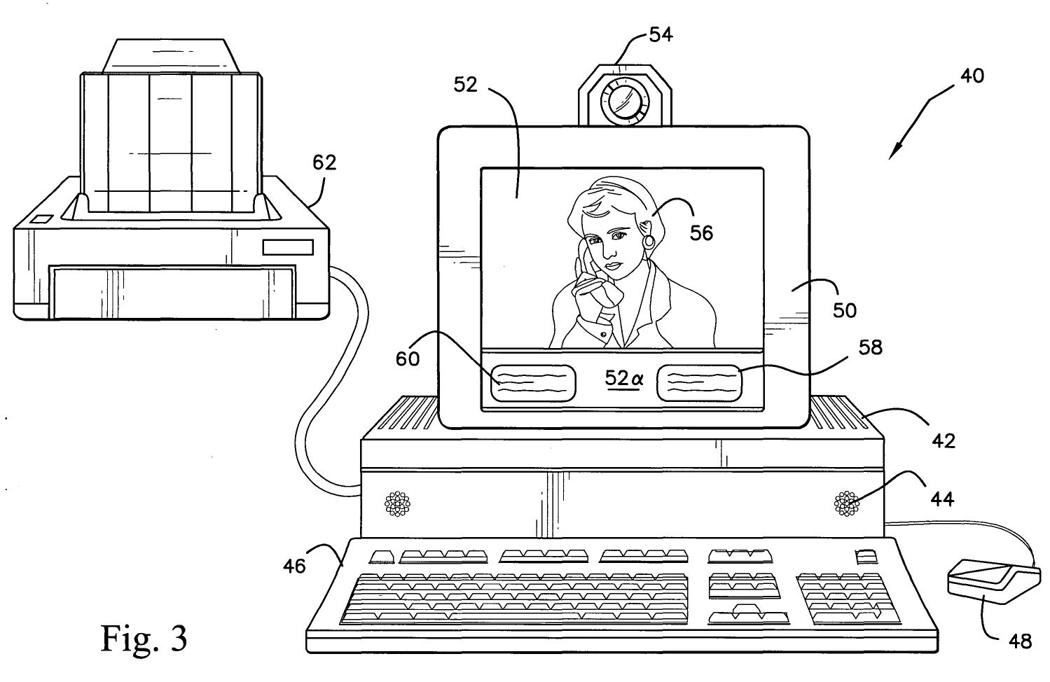

FIG. 3 shows an exemplary embodiment of a servicing pharmacy computer system 40 for use by a pharmacist when servicing a customer at a kiosk. The servicing pharmacy computer system 40 is comprised of any suitable computer system adapted to provide the functionality described herein. For example, the servicing computer system 40 may include a computer 42 with suitable software, a keyboard 46, a mouse 48, a monitor 50 and a printer 62. A speaker/microphone 44 and a camera 54 are provided and define a videoconference system that is compatible with the videoconference system on the kiosk 10. In this way, a videoconference can be established between the customer 56 at the kiosk 10 and the live pharmacist 36 at the servicing pharmacy computer 40 in order to obtain consultation and/or prescription filling services.

The preferred operation of the virtual pharmacy kiosk system is as follows. The customer approaches the kiosk 10 with a prescription from their doctor in hand. The Kiosk indicates to the customer that he/she should “Touch Here” (i.e., touch the screen or button) to begin (see FIG. 1). Upon touching the button on the kiosk, a videoconference request is initiated to a nearby (or remote) servicing pharmacy. At that pharmacy, a ringing tone is generated on the servicing computer 40. A button on the computer allows the pharmacist to accept the incoming conference request and the videoconference is initiated. Once initiated, the pharmacist 36 and the customer 56 can see and hear each other using the computer monitor and speakers. If the customer desires additional privacy, he/she can pick up the attached telephone handset 26. Once the handset is picked up, the computer speaker(s) 22 are muted. During the videoconference, the pharmacist may instruct the customer to insert one or more documents into the document scanner (such as a prescription, credit card and/or identification). Any documents inserted into the document scanner are automatically scanned, and the resultant image is transferred to the servicing pharmacy computer 40 for viewing by the pharmacist. Any images received at the servicing pharmacy computer are automatically displayed upon the computer monitor 52. For example, as shown in FIG. 3, a portion 52a of the display 52 can be used to display the prescription 60 and/or any other information 58 that is scanned by the customer at the kiosk 10. When these images are displayed, the pharmacist has the ability to view and/or print them on printer 62. Once the pharmacist at the servicing pharmacy has completed servicing the customer, he/she can click a button on the computer system 40 that disconnects the videoconference. At that time, the videoconference software shuts down on both the kiosk 10 and the servicing computer 40. The kiosk is then returned to its original state, waiting for another customer to touch the screen (or otherwise activate the Kiosk) and restart the process.

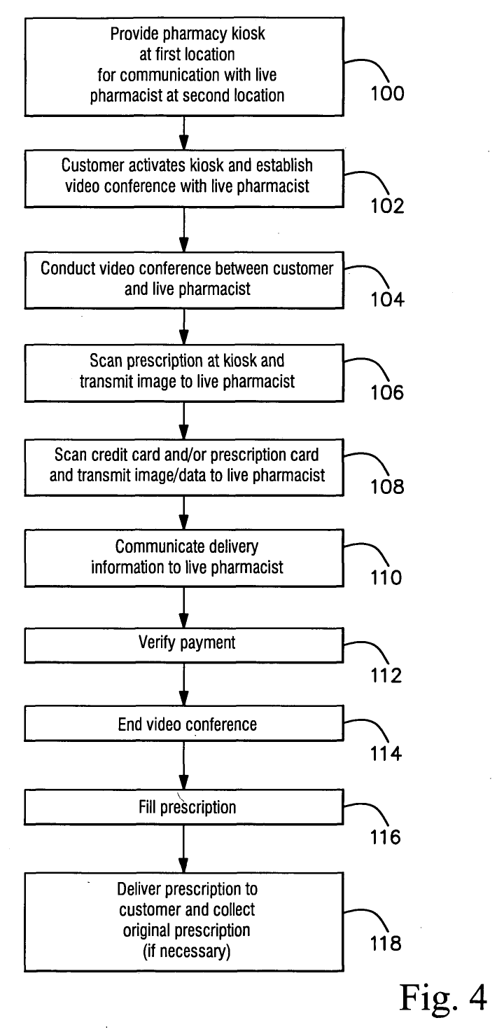

FIG. 4 provides a high-level flow chart of an exemplary overall method used to provide pharmacy services requiring a prescription to be filled, in accordance with the instant invention. The method includes: providing a pharmacy kiosk computer system at a first location for use by the customer needing pharmacy services for communication with a servicing pharmacy computer system operated by a pharmacist at a second location remote from the first location (step 100); establishing a pharmacy services videoconference between the customer at the pharmacy kiosk computer system and the pharmacist at the servicing pharmacy computer system (step 102); conducting a videoconference between the customer and the pharmacist (step 104); scanning a prescription at the kiosk and transmitting the scanned image to the pharmacist (step 106); scanning a credit card and/or insurance card and transmitting the scanned information to the pharmacist (step 108); communicating delivery/pick-up instructions to the pharmacist through the videoconference (step 110); verifying payment/insurance information (step 112); ending the videoconference (step 114); filling the prescription by the pharmacist (step 116); and delivering the product to the customer in accordance with the delivery/pick-up instructions provided during the videoconference (step 118). If necessary, the original prescription issued by the doctor can by collected from the customer when the product is delivered or picked up.

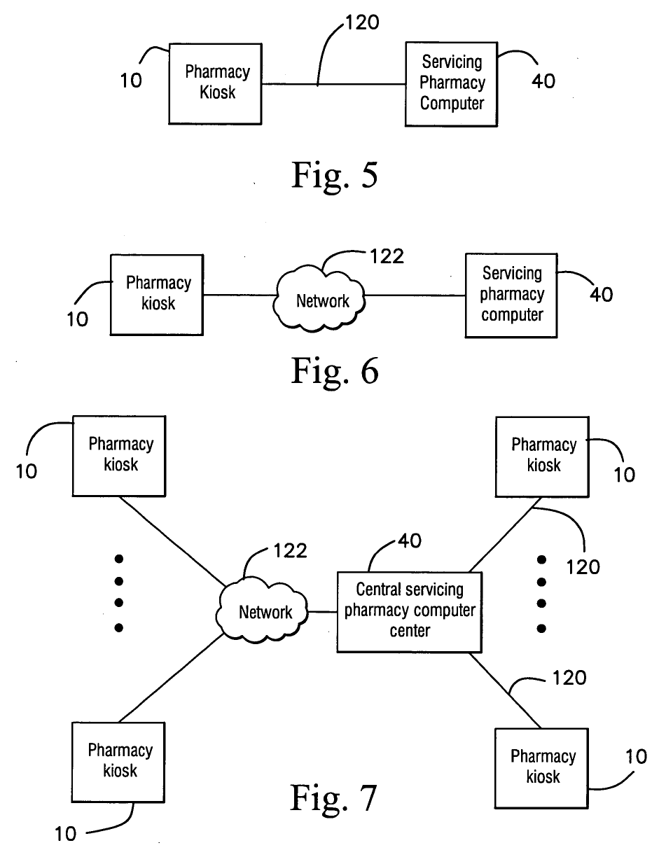

FIG. 5 is a schematic diagram of the overall virtual pharmacy system in accordance with a first embodiment of the instant invention, wherein the virtual pharmacy kiosk 10 is directly connected to the servicing pharmacy computer system 40. This first embodiment preferably uses a high-speed telephone connection 120, such as a fragmented T1 connection. However, any other suitable direct connection can also be used for this embodiment.

FIG. 6 is a schematic diagram of the overall virtual pharmacy system in accordance with a second embodiment of the instant invention, wherein the virtual pharmacy kiosk 10 is connected to the servicing pharmacy computer system 40 through a computer network 122, such as the Internet. However, any other suitable type of computer network can also be used for this embodiment. FIG. 7 is a schematic diagram of the overall virtual pharmacy system in accordance with a third embodiment of the instant invention, wherein a plurality of virtual pharmacy kiosks 10 are connected to the servicing pharmacy computer system 40 using both of the different connection types of FIGS. 5 and 6. In this embodiment, the servicing pharmacy computer system 40 is a centralized facility that services many remotely located kiosks 10. The centralized facility may be a special facility specifically designed for servicing the kiosks 10. For example, this facility could have one or many pharmacists that are dedicated to responding to calls from the various kiosks 10. This embodiment could also use a single connection type, rather than the multiple types shown in FIG. 7. The centralized facility could also be a web site on the World Wide Web which is accessed by the kiosks 10.

The kiosks 10 can be located in any desired location. However, in one preferred embodiment, a kiosk is located in a drugstore having a pharmacy and the kiosk is designed for use when the drugstore is open but the pharmacy is closed. In this embodiment, the kiosk communicates with a pharmacist in another drugstore where the pharmacy is open. In this way, a chain of drugstores can use the present invention to allow 24 hour pharmacy services without the need to have an actual pharmacist on duty at each 24 hour location at all times. In another embodiment, the kiosk of the invention can be located in any private or public location. For example, a kiosk could be provided in a large office building or apartment building for use by the tenants/residents of the building to obtain pharmacy services in a convenient manner without the need to go to a drugstore. In addition, the kiosk could be located in retirement/nursing homes, hotels, hospitals, doctor's offices, medical supply centers, malls, cruise ships, restaurants or any other retail or other desired locations.

In accordance with another embodiment of the invention, the kiosk itself can have other forms. For example, the kiosk could accept electronic prescriptions through a suitable interface, rather than requiring that the customer scan a paper prescription. In addition, the kiosk could be substituted for a portable electronic device, such as a PDA, which would provide the same functionality as described above. In other words, the customer could conduct the videoconference through his or her own portable electronic device or their own personal computer having suitable software and hardware for achieving the functionality described herein.

Example Implementation

The following provides an identification of some exemplary components that can be used to implement the invention: Kiosk Computer: The kiosk computer may be the IBM Netvista kiosk. This is an AMD K6-2 400- based computer with 64 MB of RAM, an integrated TFT touchscreen monitor, and a motion detecting presence sensor to detect motion from up to 10 feet away. The Netvista kiosk runs the Windows 2000 operating system. Servicing Pharmacy Computer: This may be a Compac Windows 2000 based PC, equipped with a USB port to connect the video conference system.

Video Conference System: The Videoconference system may be the VCON Vigo, a USB based solution. The specifications for this system are below:

[image]

Document Scanner: The document scanner can be the Visioneer Strobe Pro. This unit is desirable because of the small footprint and speed of scanning. The product specific specifications are:

300×600 dpi Optical Resolution

30-bit internal color (24-bit output)

8.5″×30″ maximum scan size

Business Card minimum scan size

Videoconference Software: The videoconference software currently used by the inventor is custom developed software specifically for the kiosk application by AIS, Inc, using components provided in the VCON software development kit.

Communication Interface: The communication interface used by the inventor is established using custom software developed by AIS, Inc.

Document Display Utility: The document display utility is preferably the Kodak Image Preview application, a utility that is included in the Windows 2000 operating system. This utility permits the user to display and optionally print images.

The example components identified above are only exemplary and various other or substitute components can be used without departing from the scope of the invention.

What is claimed is:

1. A system for providing pharmacy services to a customer at a location where a live pharmacist is not available, said system comprising:
a pharmacy kiosk computer system including a videoconference arrangement, a document scanner and communication system; and
a servicing pharmacy computer system remotely located from the pharmacy kiosk computer system, the servicing pharmacy computer system including a videoconference arrangement and a communication system;
wherein the pharmacy kiosk computer system and the servicing pharmacy computer system are interconnected via their respective communication systems in a manner that enables a pharmacy service videoconference to be established between a customer located at the pharmacy kiosk computer system and a live pharmacist at the servicing pharmacy computer system and enables information scanned on the document scanner of the pharmacy kiosk computer system to be transmitted to the servicing pharmacy computer system for review by the live pharmacist.

2. The system for providing pharmacy services of claim 1, wherein the pharmacy kiosk computer system further includes a payment scanner which enables payment information for the pharmacy service to be transmitted from the pharmacy kiosk computer system to the servicing pharmacy computer system.

3. The system for providing pharmacy services of claim 1, wherein the pharmacy kiosk computer system is located in a store having a pharmacy, and the pharmacy kiosk computer system is designed for use when the store is open but the pharmacy located in the store is closed.

4. The system for providing pharmacy services of claim 3, wherein the servicing pharmacy computer system is located at a pharmacy and is designed for use by a pharmacist working at the pharmacy.

5. The system for providing pharmacy services of claim 1, wherein the document scanner on the pharmacy kiosk computer system is operable to scan prescriptions, wherein upon scanning the prescription an image file containing the prescription information is transmitted to the servicing pharmacy computer system.

6. The system for providing pharmacy services of claim 5, wherein the document scanner is operable to scan identification information and insurance information, wherein upon scanning, the identification information and insurance information is transmitted to the servicing pharmacy computer system.

7. The system for providing pharmacy services of claim 5, wherein the servicing pharmacy computer system is operable to display to the pharmacist the image file containing the prescription information.

8. The system for providing pharmacy services of claim 5, wherein the servicing pharmacy computer system includes a printer for enabling the image file containing the prescription information to be printed.

9. The system for providing pharmacy services of claim 1, wherein the pharmacy kiosk computer system includes a handset that includes a speaker in an ear piece and a microphone in a mouth piece for enabling private communications with the live pharmacist during the pharmacy service videoconference.

10. The system for providing pharmacy services of claim 1, wherein the videoconference arrangement on both the pharmacy kiosk computer system and the servicing pharmacy computer system includes a camera, a speaker and a microphone.

11. The system for providing pharmacy services of claim 1, wherein the pharmacy kiosk computer system includes a touchscreen that can be used by the customer to activate and to interact with the pharmacy kiosk computer system.

12. The system for providing pharmacy services of claim 1, wherein, upon activation of the pharmacy kiosk computer system by a customer, an indication is provided by the servicing pharmacy computer system to the live pharmacist that a customer at the pharmacy kiosk computer system is requesting pharmacy services.

13. The system for providing pharmacy services of claim 1, wherein the pharmacy kiosk computer system includes a motion sensor that activates an attract mode on the pharmacy kiosk computer system when a potential customer is within a predetermined distance from the pharmacy kiosk computer system.

14. The system for providing pharmacy services of claim 1, wherein the pharmacy kiosk computer system and the servicing pharmacy computer system are interconnected via their respective communication systems using a high-speed telephone connection.

15. The system for providing pharmacy services of claim 1, wherein the pharmacy kiosk computer system and the servicing pharmacy computer system are interconnected via their respective communication systems using the Internet.

16. The system for providing pharmacy services of claim 1, further including a plurality of said pharmacy kiosk computer systems at different locations, wherein each of said plurality of pharmacy kiosk computer systems are interconnected with the servicing pharmacy computer system, thereby enabling the live pharmacist at the servicing pharmacy computer system to service customers at the different locations.

17. A method of providing pharmacy services to a customer at a location where a live pharmacist is not available, said method comprising:
providing a pharmacy kiosk computer system at a first location for use by the customer needing pharmacy services;
providing a servicing pharmacy computer system for use by a pharmacist at a second location remote from the first location;
establishing a pharmacy services videoconference between the customer at the pharmacy kiosk computer system and the pharmacist at the servicing pharmacy computer system;
conducting a videoconference between the customer and the pharmacist;
providing information from the customer to the pharmacist in order to enable the pharmacist to service the customer; and
ending the pharmacy services videoconference.

18. The method of claim 17, wherein providing information from the customer to the pharmacist includes scanning a prescription at the pharmacy kiosk computer system and transmitting the prescription information to the servicing pharmacy computer system.

19. The method of claim 18, wherein providing information from the customer to the pharmacist further includes scanning an identification of the customer at the pharmacy kiosk computer system and transmitting the identification information to the servicing pharmacy computer system.

20. The method of claim 19, wherein providing information from the customer to the pharmacist further includes scanning insurance information for the customer at the pharmacy kiosk computer system and transmitting the insurance information to the servicing pharmacy computer system.

21. The method of claim 19, wherein providing information from the customer to the pharmacist further includes scanning payment information at the pharmacy kiosk computer system and transmitting the payment information to the servicing pharmacy computer system.

22. The method of claim 17, wherein providing information from the customer to the pharmacist includes scanning at least one of prescription information, identification information, insurance information and payment information at the pharmacy kiosk computer system and transmitting the scanned information to the servicing pharmacy computer system.

23. The method of claim 22, further including receiving delivery instructions from the customer during the pharmacy services videoconference.

24. The method of claim 23, further including filling or refilling a prescription for the customer based on information received by the pharmacist from the customer using the pharmacy kiosk computer system.

25. The method of claim 24, further including delivering the filled or refilled prescription to the customer in accordance with delivery instructions received from the customer during the pharmacy services videoconference.

26. The method of claim 24, further including obtaining an original prescription from the customer upon delivery of a filled prescription.

27. The method of claim 17, further including providing a plurality of said pharmacy kiosk computer systems at different locations, wherein each of said pharmacy kiosk computer systems is operable to establish a videoconference with the servicing pharmacy computer system.
